(19) United States
(12) Patent Application Publication
(10) Pub. No.: US 2026/0316570 A1
(43) Pub. Date: Oct. 15, 2026

(54) ADAPTIVE FILTER CHAIN FOR DISPLAYING A SURROUNDINGS MODEL IN A VEHICLE

(71) Applicant: MERCEDES-BENZ GROUP AG, Stuttgart (DE)

(72) Inventor: Christian SCHNEIDER, Radolfzell am Bodensee (DE)

(21) Appl. No.: 19/487,650

(22) PCT Filed: Apr. 17, 2024
(86) PCT No.: PCT/EP2024/060329

§ 371 Date: Nov. 25, 2025

(30) Foreign Application Priority Data
May 30, 2023 (DE) 10 2023 002 181.4

(51) Int. Cl. B60K 35/81; B60K 35/22; B60K 35/28

(52) U.S. Cl. CPC B60K 35/81; B60K 35/22; B60K 35/285; B60K 2360/149; B60K 2360/21

(57) ABSTRACT

Information about objects in the surroundings of a vehicle are displayed for a driver. A computing unit determines driver gaze directions using a driver observation camera with reference to the surroundings and checks whether an object in the surroundings is being tracked thereby. If the object is being tracked, a deviation between the course of the gaze directions directed towards the tracked object and a position course according to the data of a surroundings sensor unit in a projection image is determined. To minimize the deviation, adjusts a filter parameter of a filter to be applied to the sensor data to display the tracked object, and controls the display unit for the filtered display of the time-dependent position of the tracked object.

### BACKGROUND AND SUMMARY OF THE INVENTION

Exemplary embodiments of the invention relate to a system for displaying information about objects in the surroundings of a vehicle, a vehicle having such a system, and a method for displaying information about objects in the surroundings of a vehicle.

In the prior art it is known to generate and to render a surroundings model obtained from sensor data as an image in order to reproduce sensor data about objects in the surroundings and to display it on a display device.

In this context, DE 10 2021 201 065 A1 relates to a method for displaying a surroundings model of a surroundings of a motor vehicle by means of a surroundings detection system of the motor vehicle, in which the surroundings of the motor vehicle are detected by means of at least one detection device of the surroundings detection system, and the detected surroundings are displayed graphically on a display device of the surroundings detection system as the surroundings model, wherein, in the surroundings model, a multi-lane roadway on which the motor vehicle is located and which has at least two lanes that can be driven in the same direction is displayed, wherein swarm data are received from an electronic computing device external to the motor vehicle by means of a swarm data receiving device of the surroundings detection system, wherein the multi-lane roadway is detected and displayed base on the swarm data.

Furthermore, DE 10 2018 112 345 A1 relates to a method for generating high dynamic range images with an HDR camera system, wherein the method comprises recording a plurality of camera exposures with a camera of the HDR camera system, generating a first HDR image from a first subset of the plurality of camera exposures, wherein each camera exposure of the first subset has a different exposure value, and generating a second HDR image from a second subset of the plurality of camera exposures, wherein the second subset comprises at least one exposure from the first subset and at least one additional exposure, which has been recorded more recently than the exposures of the first subset, wherein each exposure of the second subset has a different exposure value.

Here, a sensor unit in the vehicle typically serves the purpose of obtaining data for a driver assistance system. This occurs within the framework of surroundings perception, which has the primary task of generating data for driver assistance systems such as the driving functions or parking functions of the vehicle. Accordingly, the sensor data is primarily suitable for such driver assistance systems, but not necessarily optimal for visualizing a surroundings model with moving and/or static objects in the surroundings of the vehicle, which is determined by means of this data of the sensor unit. Here, such a surroundings model can, for example, be generated from the data from the sensor unit directly or by means of the result of a static or dynamic sensor data fusion. This process is also called “navistency.” Here, ADAS (short for “advanced driver assistance system”) typically displays sensor data and navigation data to the driver on a central screen.

The visualization of the surroundings model serves, in particular, the purpose of making the behavior of such a driver assistance system understandable for the driver, while the visualization itself is, however, primarily based on the data in the perception channel of the vehicle, which can use a plurality of sensors of the vehicle individually or in combination with one another through data fusion. However, due to the aforementioned partial lack of suitability of the data from the surroundings model for visualization, the visualized data can have a high temporal jitter or a spatial offset, each resulting in spatial instability of a displayed object relative to the surroundings—for the viewing driver, such behavior can be apparent as wobbly objects in the depiction and can be distracting. The quality of object recognition can depend heavily on the object class (above all with data-driven approaches) and the respective surroundings conditions. Therefore, it is advisable to use a filter chain (for example box filters over multiple frames or Kalman filters) to clean up the behavior of the objects with regard to their position in their display.

Removing interference, noise, and artifacts in visualizations using filter loops tends to be laborious. This approach furthermore leads to the filter filtering all objects equally, independent of the sensor quality and the ambient conditions—and this in turn can lead to excessive or insufficient filtering of the objects to be depicted in terms of their position. Such a filter chain with suboptimal parameters can even lead to objects appearing sluggish in the visualization. This effect occurs particularly when temporal filters with fixed window widths are applied to the data. In doing so, the data has a temporal stability, but at the same time makes it appear sluggish for visualization. Accordingly, a conflict of objectives arises between artifact cleaning and realistic display on a display unit.

Exemplary embodiments of the invention are directed to improving filtering of information to be displayed about objects in their position in a surroundings model.

A first aspect of the invention relates to a system for displaying information about objects in the surroundings of a vehicle, having a sensor unit for determining sensor data about the objects, a driver observation camera, a computing unit, and a display unit, wherein the computing unit is designed to determine a respectively current viewing direction of the driver by means of the data from the driver observation camera, to relate the respective viewing direction to a viewed target in the surroundings, and to check a course of the viewed targets to determine whether i) the viewing directions track an object in the surroundings during a predetermined period of time, and whether ii) the tracked object corresponds to an object detected by the sensor unit and to be depicted on the display unit during the predetermined period of time, and when i) and ii) are present, to determine a deviation between the course of the viewing directions directed at the tracked object and a positional course of the respective object determined by means of the sensor unit on the basis of the sensor data in a common projection image suitable for determining the deviation, and to adapt at least one filter parameter of a filter to be applied to the sensor data for displaying the tracked object in such a way that the position course of the respective object to be displayed by applying the filter on the display unit is changed in such a way that the deviation is reduced, and to then control the display unit in such a way that the time-dependent position of the displayed tracked object on the display unit is determined by the adjusted filter parameter.

Exemplary embodiments of the invention observe eye movements of the driver and use this in order to combine and to harmonize the information thus available with that from the surroundings perception channel of the vehicle. In other words, the data obtained from the sensor unit for displaying dynamic and/or static objects in the surroundings of the vehicle are supported by relevant information from the eye movements of the driver and the resulting gaze directions.

In particular, this support is carried out by one or more parameters of one or more filters, which in particular determine a dynamic bandwidth of the one or more filters, serving as an optimization variable in order to optimize a position course of a gaze-tracked object for display; this is carried out, in particular, in such a way that this position course of a gaze-tracked object follows the gaze trajectory with respect to the surroundings of the vehicle and thus ideally the object itself. The fact that this tracking behavior emerges can be attributed to the value of the at least one filter parameter, which is correspondingly optimized.

In principle, it is here irrelevant as to whether a filter parameter of one or more filters is adjusted, whether one or more filters are used, and whether many filter parameters of one filter or filter parameters of several filters are adjusted. The only decisive factor is that the behavior of an applied filter chain is adjusted, as explained above and below. A Kalman filter, in particular, can be used as a filter. Examples for different filter parameters are a filter window and the filter function.

The driver observation camera directly records the eye movements. From the eye movements, a gaze direction of each eye can be determined, which also determines the focus. In order to be able to allocate the gaze direction of the driver to the surroundings, a data format correspondingly compatible with the information from the sensor unit is required. This is achieved by means of the projection image, in which, in particular, the information of the sensor unit about the surroundings is mapped onto this preferably two-dimensional projection image, and the gaze directions are allocated to corresponding coordinates in this projection image. With the projection image, a common basis for comparing the information of the sensor unit about the surroundings and the gaze directions into the surroundings is created.

A so-called “range image” is preferably used as the projection image (this is substantially the result of projecting 3D surroundings onto a 2D plane). Direct geometric comparisons can thus be made regarding which paths the gaze direction of the driver is following in the surroundings, or which object moving relative to the rest of the surroundings they are following, and what information the sensor unit has regarding these paths or objects.

In particular, here the computing unit determines, based on these gaze directions of the driver, whether the driver is following an object with their gaze over a predetermined period of time, i.e., whether they are focusing on it and their gaze is following the object over the specified period of time. The computing unit thus ensures that the driver is consistently observing and focusing on a moving object over a longer period of time. The check takes place, in particular, by a region around a fixed window on the projection image, such as a “range image” being determined. If the region is consistently constant, it can be assumed that the same object-related position is focused. From this, a spline of a moving object on the 2D plane of the projection image, such as a “range image,” can be derived. A respective spline is then used as a reference spline in order to adjust at least one filter parameter.

Once these requirements are met, relevant information based on the recorded eye movements of the driver is available, which can be further used for further processing. Therefore, it is still being examined whether the object tracked by the gaze of the driver has also been detected with sufficient information from the sensor unit, and whether this object should be displayed on a display unit of the vehicle, in particular a central screen in the interior of the vehicle, in such a way that the driver can create a spatial image of the surroundings according to the display unit using the surroundings model depicted on the display unit.

If these conditions are met, the method described above is continued, after which a geometric deviation of the path of the tracked object is compared in the projection image according to the data from the driver observation camera with the position course from the sensor unit. The trajectory of an object moving relative to its surroundings in 3D space can be recorded by the sensor unit and adjusted by means of the filter. This updated filter chain is now preferentially projected into the projection image and compared with the reference spline. The resulting deviation can be defined, for example, as the orthogonal L2 distance.

The goal of the subsequent optimization is, in particular, to minimize this deviation. Here, the at least one filter parameter is adjusted in such a way that the position course according to the sensor unit adjusts to the tracked trajectory according to the gaze behavior of the driver. Thus, an improved filter parameter value is obtained, and the position course of the object can be displayed more reliably and realistically on the display unit. If the corresponding minimum or the termination criterion is reached, the optimization is terminated, and the underlying filter set is applied in order to filter the ADAS perception data for a corresponding period of time and make it available for visualization.

The object that is supplied with the filter with the filter parameter to be changed for display on the display in its course is, in particular, a dynamic object, i.e., an object that is moving relative to the rest of the surroundings, such as a further road user. Further road users in particular significantly determine the behavior of a driver assistance system, in particular when it operates reactively, i.e., exerts a reaction on the surrounding traffic. It is precisely such reactions that are of interest to the driver of the vehicle to understand them, which is why the surroundings model with the in particular moving objects in the surroundings of the vehicle is depicted on the display unit.

An optimization loop can be initialized either at predetermined time intervals or linked to the availability of the reference spline; the latter is particularly advantageous in rural surroundings. Coupling it to a perception quality measure is also conceivable. Continuous repetition of the optimization is typically necessary since the quality of the sensor data can fluctuate significantly and may depend on the degree of contamination of the sensors, the prevailing lighting conditions, or weather conditions.

Advantageous effects of the invention are that, through the adaptive adjustment of the assistance visualization, the objects in the surroundings are depicted more naturally on the display unit, regardless of light and weather conditions. If moving objects are depicted in the surroundings of the vehicle, they can moreover be depicted more effectively, independent of the static scenery. The described system and method can additionally adjust a plurality of filter parameters during optimization and is independent of the concrete sensor types in the sensor unit, and whether they are fused with one another. Individual sensors of the sensor unit can be, for example, cameras, radar, or lidar.

According to an advantageous embodiment, the computing unit is designed to project data of the sensor unit into a two-dimensional projection image in order to determine the deviation, and to allocate the viewing directions to the coordinates of the projection image, such that the course of the observed targets of the gaze directions in the projection image and the position course of a respective object in the projection image are related to the same standardized positions of the surroundings and thus a respective direct geometric difference can be ascertained to determine the deviation.

The geometric difference is preferably calculated as an L2 distance, particularly preferably as an integral valid for a respective point in time of the distances between the spline of the focused viewpoints on the tracked object and the path course of the object in relation to the same reference projection image in comparison to the surroundings according to the sensor data.

According to a further advantageous embodiment, the filter comprises at least one of the following: Kalman filter, box filter, low pass filter, floating average filter.

According to a further advantageous embodiment, the computing unit is designed to classify a respective object which is detected by the sensor unit and, depending on the result of the classification, to determine and apply special filter parameters depending on the class for depicting the respective object on the display unit.

Examples of different classes into which objects moving in relation to their surroundings can be divided are: cyclists, passenger cars, trucks, pedestrians.

According to a further advantageous embodiment, the computing unit is designed to determine the predetermined period of time depending on the classification of the respective object and/or depending on the distance of the respective object from the vehicle.

According to a further advantageous embodiment, the system furthermore comprises a communication module, wherein the computing unit is designed to transmit the at least one adjusted filter parameter to a central computer or to a further road user, in particular a further road user in the same class as the vehicle, by means of the communication module.

Here, the class division of one's own vehicle can be carried out in the same way as the classification of the other road users. Thus, in particular, the respective filter parameters determined through optimization can only be passed on to further passenger vehicles when one's own vehicle is a passenger car.

According to a further advantageous embodiment, the computing unit is designed to check whether the gaze directions track an object of the surroundings during the predetermined period of time and to evaluate whether the targets of the gaze directions lie within a planar region around a respective object projected into the surroundings of the vehicle, at least during the predetermined period of time.

According to a further advantageous embodiment, the computing unit is designed to determine the size of the planar region depending on the distance of the respective object from the vehicle.

According to a further advantageous embodiment, the computing unit is designed to check whether the tracked object corresponds to an object detected by the sensor unit and to be depicted on the display unit during the predetermined period of time, and to carry out an image-analytical similarity comparison, in particular a determination of a “structural similarity index measure”.

A further aspect of the invention relates to a vehicle with a system as described above and below. Advantages and preferred developments of the proposed vehicle emerge from an analogous and corresponding application of the statements made above in connection with the proposed system.

A further aspect of the invention relates to a method for displaying information about objects in the surroundings of a vehicle, having the following steps:
Determining sensor data about the objects by a sensor unit of the vehicle, and respectively by a computing unit:
Determining a respectively current gaze direction of the driver by means of the data of a driver observation camera of the vehicle;
Relating the respective gaze direction to a viewed target in the surroundings, and checking a course of the viewed targets to determine whether i) the gaze directions track an object in the surroundings during a predetermined period of time, and whether ii) the tracked object corresponds to an object detected by the sensor unit and to be depicted on the display unit during the predetermined period of time, and when i) and ii) are present:
Determining a deviation between the course of the gaze directions directed at the tracked object and a position course of the respective object determined by means of the sensor unit on the basis of the sensor data in a common projection image suitable for determining the deviation;
Adjusting at least one filter parameter of a filter to be applied to the sensor data to display the tracked object in such a way that the position course of the respective object to be displayed on the display unit by applying the filter is changed in such a way that the deviation is reduced; and subsequently
Controlling the display unit in such a way that the time-dependent position of the displayed tracked object on the display unit is determined by the adjusted filter parameter.

Advantages and preferred developments of the proposed method emerge from an analogous and corresponding transfer of the statements made above in connection with the proposed system.

Further advantages, features and details emerge from the description below in which—optionally with reference to the drawings—at least one exemplary embodiment is described in detail. The same, similar and/or functionally identical parts are provided with the same reference numbers.

### BRIEF DESCRIPTION OF THE DRAWING FIGURES

Here are shown in:

FIG. 1: A system in a vehicle for displaying information about objects in the surroundings of the vehicle according to an exemplary embodiment of the invention.

FIG. 2: A method for displaying information about objects in the surroundings of a vehicle according to an exemplary embodiment of the invention.

The depictions in the Figures are schematic and not to scale.

### DETAILED DESCRIPTION

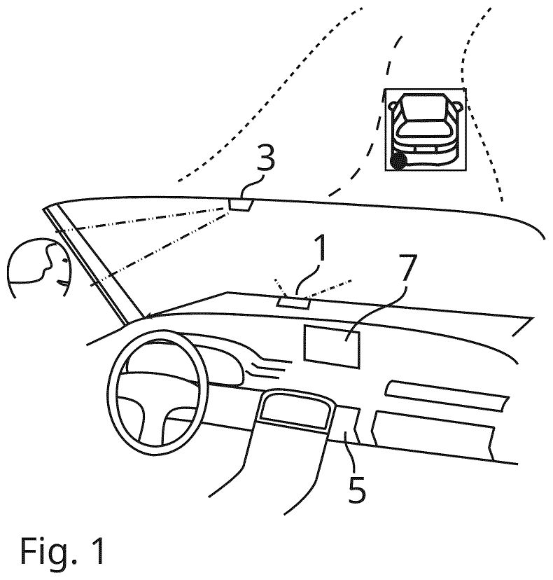

FIG. 1 shows a cut-out of a vehicle with a system for displaying information about objects in the surroundings of the vehicle. As part of the system, the vehicle has a sensor unit 1 for recording sensor data about the surroundings of the vehicle. Thus, corresponding information about moving objects, such as further road users, who are located in the detectable surroundings of the vehicle, is also received in this sensor data. The sensor data primarily serves to provide a driver assistance system or an automatic driving control system of the vehicle with respectively current information about the surroundings and the road users present therein, such that it can carry out appropriate reactions.

To make the reactions more understandable for the driver of the vehicle, the data about the road users is depicted on a display unit 7 of the vehicle in such a way that real movements of the actual road users are mapped by movements of the representations of these road users on the display unit 7. Since the sensor data is designed with particular suitability for use in the driver assistance system or the automatic driving control system of the vehicle, but not necessarily for suitability for depiction on a display unit 7, one or more filters are applied in order to adjust this sensor data with the information about the other road users and their temporal position course, such that a realistic and smooth position course of these movements of the further road users is achieved on the display unit 7. This at least one filter has at least one filter parameter, and the application of the filter and the control of the display unit 7 is assumed by a computing unit 5 of the system, in particular but not necessarily arranged in the vehicle.

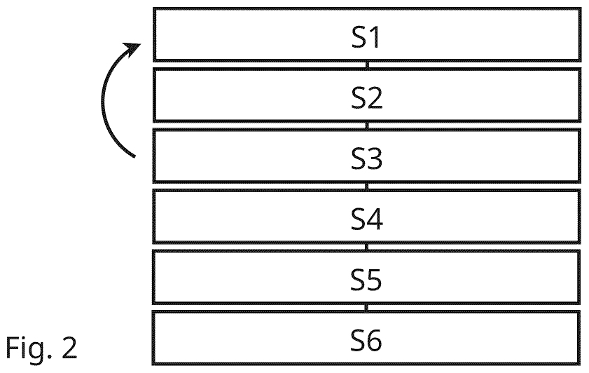

Since a predetermined filter parameter cannot be optimal for all situations, the behavior of the driver is advantageously used where it contains relevant information in order to improve the display of a position course of a further road user in the surroundings of the vehicle. For this purpose, the temporal course of gaze directions of the driver into the surroundings is recorded by means of a driver observation camera 3, and the gaze directions are mapped onto such a projection image of the respectively current surroundings, into which the information captured by the sensor unit 1 is also mapped. The position course, which is determined by the computing unit 5 by sweeping the gaze directions across the surroundings, and the position course of a further road user determined by the sensor unit 1, also mapped onto the projection image, are compared by the computing unit 5 when the computing unit 5 has already determined that a focused gaze point is maintained on a further road user for a predetermined period of time, which is sketched in FIG. 1 as a black, solid circle within a rectangular, defined region around the further road user. The rectangular defined region is defined by means of the sensor data of the sensor unit 1 as the region that moves physically with the further road user, and within which the focus of the gaze direction of the driver must lie above a predetermined period of time, such that the computing unit 5 can recognize that the driver is actually following the object for the predetermined period of time. If this is the case, usable information is available in order to be able to exploit the tracking of the further road user by the driver with their gaze in order to optimize the filter. Here, the filter parameter is optimized in such a way that the deviation of the movement data of the further road user calculated by means of the sensor data from the sensor unit 1 corresponds as closely as possible to that calculated by tracking the further road user with the gaze directions of the driver. The filter parameter is adjusted accordingly, and the filter parameter thus obtained is applied to depict the movement path of the further road user on the display unit 7. Further details are given in the method of FIG. 2.

FIG. 2 shows a corresponding method for displaying information about objects in the surroundings of a vehicle, which can be implemented in a system as described in FIG. 1. In a first step of the method, determining S1 sensor data about the objects is carried out by a sensor unit 1 of the vehicle for surroundings monitoring, here, cameras, radar, lidar, ultrasonic distance sensors, and further typical sensors can be used. The computing unit 5 determines S2 a respectively current gaze direction of the driver by means of data of a driver observation camera 3 of the vehicle and relates S3 the respective gaze direction to a viewed target in the surroundings by a projection image being provided in the form of a so-called “range image” and detection of the driver gaze direction on the previously derived “range image” being carried out.

Furthermore, a check is performed on the course of the observed targets as to whether i) the gaze directions track an object in the surroundings during a predetermined period of time, and whether ii) the tracked object corresponds to an object detected by the sensor unit 1 and to be depicted on the display unit 7 during the predetermined period of time. Check ii) is carried out by determining a correspondence between the focused object by the driver and the object derived from the sensor data in 3D space by means of “structural similarity index measurement,” abbreviated “SSIM”, which is compared to a predetermined threshold value. The congruence is checked by means of defined error metrics. For this purpose, the driver's focus is repeatedly determined in order to derive a reference spline of the object over several frames based on the data from the driver observation camera 3. Deriving the reference spline is carried out from the focused “range images”. Finally, determining S4 a deviation between the reference spline based on the course of the gaze directions directed at the tracked object is performed, with a position course of the respective object determined by means of the sensor unit 1 based on the sensor data, with respective references to the projection image; finally, adjusting S5 the at least one filter parameter for displaying the road user in front seen in front of the driver with his gaze is carried out, using the filter to be applied to the sensor data, such that the position course of the respective object, such as the road user from FIG. 1, to be displayed on the display unit 7 is changed by applying the filter in such a way that the deviation is reduced. Following this, controlling S6 the display unit 7 is carried out in such a way that the time-Attorney dependent position of the displayed tracked object is actually determined and displayed on the display unit 7 by the adjusted filter parameter.

Although the invention has been illustrated and explained in detail by means of preferred exemplary embodiments, the invention is not limited by the disclosed examples, and other variations can be derived therefrom by the person skilled in the art without departing from the scope of the invention. It is thus clear that a plurality of possible variations exist. It is also clear that embodiments mentioned by way of example really only represent examples that are not to be understood in any way as limiting the scope of protection, possible applications, or the configuration of the invention. Rather, the above description and the description of the figures enable the person skilled in the art to concretely implement the exemplary embodiments, wherein the person skilled in the art, with knowledge of the disclosed inventive though, can make various changes, for example with regard to the function or the arrangement of individual elements mentioned in an exemplary embodiment, without departing from the scope of protection which is defined by the claims and their legal equivalents, such as further explanations in the description.

1-11. (canceled)

12. A system configured to display information about objects in surroundings of a vehicle, the system comprising:
a sensor unit configured to determine sensor data about the objects;
a driver observation camera;
a display unit; and
a computing unit coupled to the sensor unit, driver observation camera, and display unit and configured to
determine a respectively current gaze direction of the driver using data of the driver observation camera,
relate the respective gaze direction to a viewed target in the surroundings,
check a course of the viewed target as to whether
i) the gaze directions track an object in the surroundings during a predetermined period of time, and
ii) the tracked object corresponds to an object detected by the sensor unit and to be depicted on the display unit during the predetermined period of time,
determine, when i) and ii) are satisfied, a deviation between the course of the gaze directions directed at the tracked object and a position course of the respective object determined by the sensor unit based on sensor data in a common projection image suitable for determining the deviation,
adjust at least one filter parameter of a filter to be applied to the sensor data to display the tracked object in such a way that the position course of the respective object to be displayed on the display unit by applying the filter is changed in such a way that the deviation is reduced,
subsequently control the display unit in such a way that a time-dependent position of the displayed tracked object on the display unit is determined using the adjusted filter parameters.

13. The system of claim 12, wherein the computing unit is further configured to:
project sensor data of the sensor unit into a two-dimensional projection image to determine the deviation; and
allocate the gaze directions to coordinates of the projection image such that the course of the viewed targets of the gaze directions in the projection image and the position course of a respective object in the projection image are related to same standardized positions of the surroundings and thus a respective direct geometric difference can be determined to determine the deviation.

14. The system of claim 12, wherein the filter comprises at least one of the following: Kalman filter, box filter, low pass filter, and floating average filter.

15. The system of claim 12, wherein the computing unit is further configured to:
classify a respective object detected by the sensor unit; and
depending on a result of the classification, to determine and to apply special filter parameters for depicting the respective object on the display unit depending on the result of the classification.

16. The system of claim 15, wherein the computing unit is further configured to:
determine the predetermined period of time depending on the classification of the respective object or depending on a distance of the respective object from the vehicle.

17. The system of claim 12, further comprising:
a communication module,
wherein the computing unit is configured to transmit the at least one adjusted filter parameter to a central computer or to a further road user using the communication module.

18. The system of claim 12, wherein the computing unit is further configured to:
check whether the gaze directions track an object in the surroundings during the predetermined period of time, and
evaluate whether the targets of the gaze directions lie within a planar region projected into the surroundings of the vehicle around a respective object at least during the predetermined period of time.

19. The system of claim 18, wherein the computing unit is configured to
determine a size of the planar region depending on a distance of the respective object from the vehicle.

20. The system of claim 12, wherein the computing unit is further configured to:
check whether the tracked object corresponds to an object detected by the sensor unit and to be depicted on the display unit during the predetermined period of time, and
perform an image-analytical similarity comparison.

21. A vehicle comprising:
a system configured to display information about objects in surroundings of a vehicle, the system comprising
a sensor unit configured to determine sensor data about the objects;
a driver observation camera;
a display unit; and
a computing unit coupled to the sensor unit, driver observation camera, and display unit and configured to
determine a respectively current gaze direction of the driver using data of the driver observation camera,
relate the respective gaze direction to a viewed target in the surroundings,
check a course of the viewed target as to whether
i) the gaze directions track an object in the surroundings during a predetermined period of time, and
ii) the tracked object corresponds to an object detected by the sensor unit and to be depicted on the display unit during the predetermined period of time,
determine, when i) and ii) are satisfied, a deviation between the course of the gaze directions directed at the tracked object and a position course of the respective object determined by the sensor unit based on sensor data in a common projection image suitable for determining the deviation,
adjust at least one filter parameter of a filter to be applied to the sensor data to display the tracked object in such a way that the position course of the respective object to be displayed on the display unit by applying the filter is changed in such a way that the deviation is reduced,
subsequently control the display unit in such a way that a time-dependent position of the displayed tracked object on the display unit is determined using the adjusted filter parameters.

22. A method for displaying information about objects in the surroundings of a vehicle, the method comprising:
determining sensor data about the objects by a sensor unit of the vehicle;
determining, by a computing unit of the vehicle, a respectively current gaze direction of a driver using data of a driver observation camera of the vehicle;
relating, by the computing unit, the respective gaze direction to a viewed target in the surroundings,
checking, by the computing unit, a course of the viewed targets as to whether i) the gaze directions track an object in the surroundings during a predetermined period of time;
checking, by the computing unit, whether ii) the tracked object corresponds to an object detected by the sensor unit and to be depicted on a display unit during the predetermined period of time;
determining, by the computing unit, that i) and ii) are satisfied and then
determining a deviation between the course of the gaze directions directed at the tracked object and a position course of the respective object determined using the sensor unit based on the sensor data in a common projection image suitable for ascertaining the deviation;
adjusting at least one filter parameter of a filter to be applied to the sensor data to display the tracked object in such a way that the position course of the respective object to be displayed on the display unit by applying the filter is changed in such a way that the deviation is reduced; and
subsequently controlling the display unit in such a way that a time-dependent position of the displayed tracked object on the display unit is determined by the adjusted filter parameter.
